(19) United States
(12) Patent Application Publication
(10) Pub. No.: US 2010/0252522 A1
(43) Pub. Date: Oct. 7, 2010

(54) Auxiliary Device For Installing The Lower And Upper Jib Support Of An Adjustable Auxiliary Boom On A Mobile Crane

(75) Inventors: Frank Conrad, Hornbach (DE); Jürgen Appel, Contwig (DE); Peter Orfey, Homburg (DE); Roland Kuhn, St. Ingbert (DE); Michael Martin, Illingen (DE); Udo Biwer, Eppelborn (DE); Klaus Conrad, Hornbach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Terex Demag GmbH, Zweibruecken (DE)

(21) Appl. No.: 12/596,605

(22) PCT Filed: Apr. 21, 2008
(86) PCT No.: PCT/DE08/00714

§ 371 Date: Nov. 13, 2009

(30) Foreign Application Priority Data
Apr. 19, 2007 (DE) 10 2007 019 759.6
Sep. 11, 2007 (DE) 10 2007 044 247.7

(51) Int. Cl. B66C 23/66; B66C 23/70; B23P 11/00

(52) U.S. Cl. 212/177; 29/428

(57) ABSTRACT

An auxiliary device for equipping the main boom of a mobile crane with an auxiliary boom, wherein a support is mounted near the head of the main boom, by means of which the lifting cable of the main boom may be run to a connection point on the auxiliary boom. The invention further relates to a method for equipping with an auxiliary boom.

The invention is directed to an auxiliary device for mounting the lower luffing support and upper luffing support of an adjustable auxiliary boom which is arranged at the head of the main boom of a mobile crane and to a method for mounting.

At present, auxiliary booms must be mounted by using an additional crane. The mounting process is carried out in the following manner:

First, the lower luffing support is lifted by an additional crane and deposited on a beam. The crane operator must then run along this lifted luffing support to hang the rigging gear of the additional crane. This activity is not without risk because, in its lifted position, the luffing support may be 6 m above the ground. After hanging the rigging gear of the additional crane, the actual mounting process which is carried out by the crane to be set up can proceed.

Dismantling must be carried out in the reverse manner, i.e., the lower luffing support is deposited on a beam by the dismantling crane, the crane operator hangs the rigging gear of the additional crane after navigating the lower luffing support and briefly lifts the lower luffing support so as to release. the beam. The beam is then guided manually by means of a rope parallel to the release of the lower luffing support so that it is deposited again in the transporting position together with the lower luffing support.

Accordingly, this work requires an additional crane on the one hand and risky actions by the crane operator on the luffing support.

Therefore, it is the object of the invention to provide a possibility for achieving a faster and safer mounting and dismantling of adjustable auxiliary booms.

This object is met by the features of claim 1 and according to claims 14, 15 and 16 for the method for mounting.

Preferable embodiments are indicated in the subclaims 2 to 13 and are described in the following in connection with the description of the drawings.

The invention, in particular the sequence of steps for mounting (and dismantling), will be described more fully in the following with reference to the drawings which schematically show a mobile crane in the individual mounting positions.

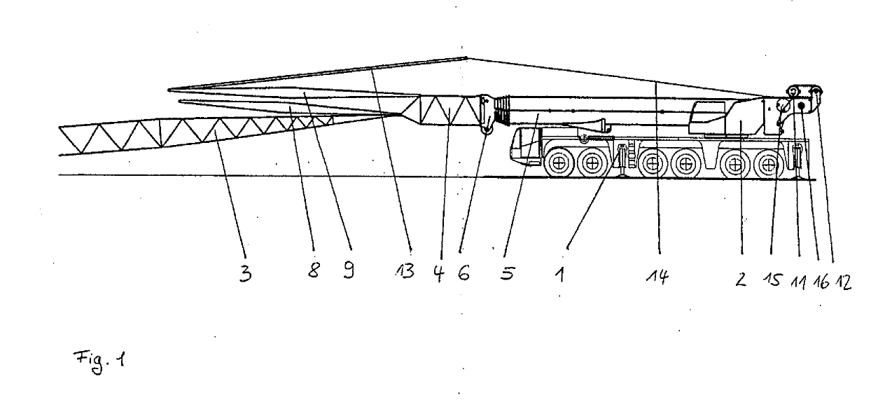

FIG. 1

The adjustable auxiliary boom 3 is mounted on the head 6 of the main boom 5, for example, by an adapter 4. However, the adapter is not absolutely necessary for carrying out this task. Mounting is carried out by suitable auxiliary devices, e.g., an auxiliary crane or forklift. The two luffing supports 8 and 9 lie flat on the auxiliary boom 3 for reasons pertaining to transport.

The hoisting rope 14 is unwound from the main hoist 15 and connected to the connection beam 13. This beam is permanently connected to the lower luffing support 9.

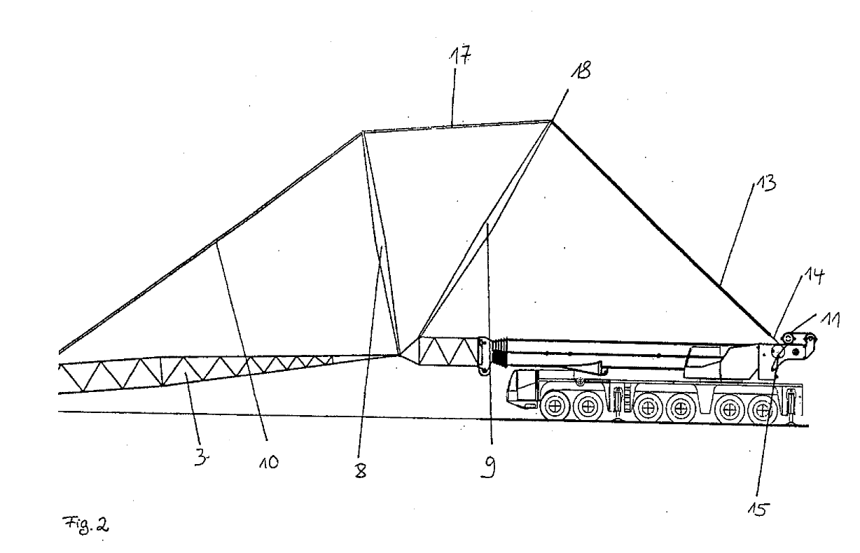

The two luffing supports are connected to one another by a traction member line 17 (FIG. 2).

By winding the hoisting rope 14 onto the hoist 15, the luffing supports 8 and 9 are erected (FIG. 2).

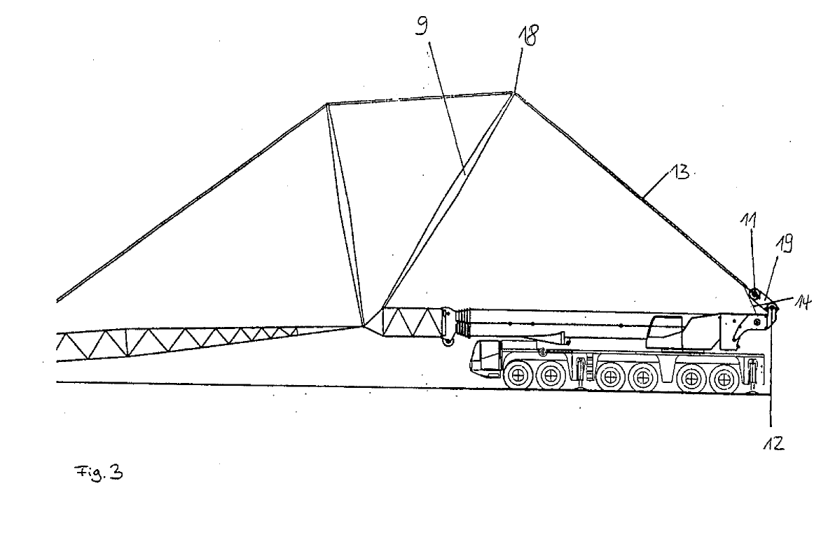

The connection beam 13 is then connected to the floating crossbar 11 (FIG. 3). As the hoisting rope 14 is unwound, the crossbar 11 aligns itself along a line from the fixed crossbar 12 to the tip 18 of the lower luffing support 9. The tackle block 19 is tightened. The hoisting rope 14 can be uncoupled from the connection beam 13 in this position.

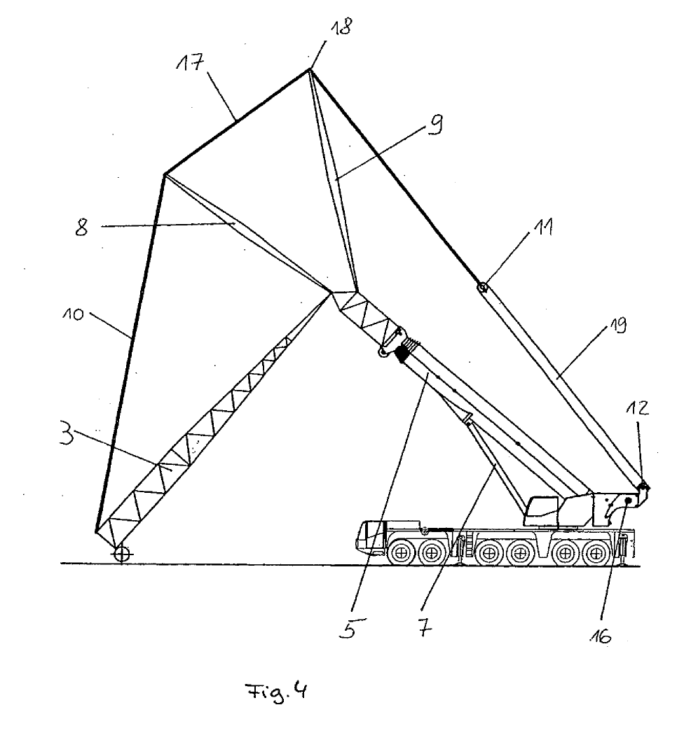

FIG. 4 shows the next work step.

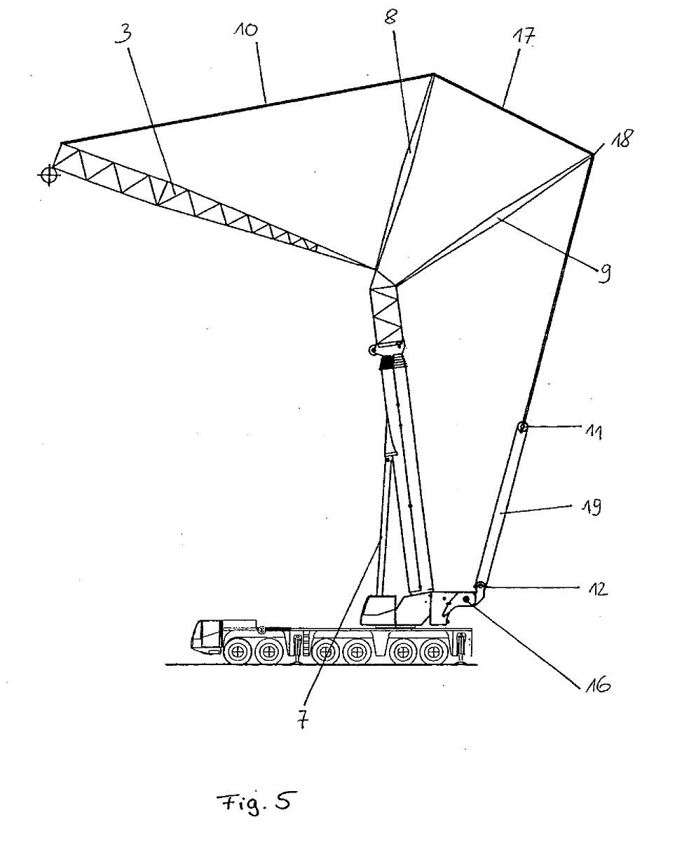

The main boom 5 is lifted by the luffing cylinder 7. At the same time, the adjusting hoist 16 is unwound so that the distance between the floating crossbar 11 and the fixed crossbar 12 is increased. Subsequently, the adjusting hoist 16 can be wound up again starting from a previously determined main boom angle position so that the distance between the floating crossbar 11 and the fixed crossbar 12 decreases. The adjustable auxiliary boom 3 is accordingly lifted from the ground because it is connected to the upper luffing support 8 by means of another traction member line 10 (FIG. 5).

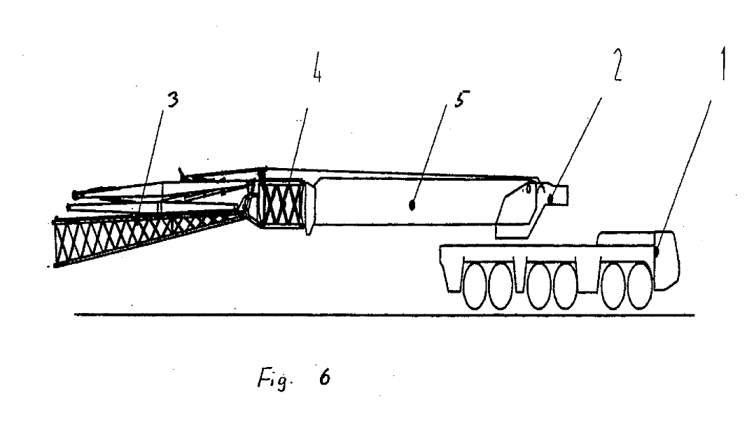

FIG. 6

The adjustable auxiliary boom 3 is mounted on the head of the main boom 5 by an adapter 4 (the adapter is not strictly necessary for carrying out this task). Mounting is carried out by suitable auxiliary devices, e.g., an auxiliary crane or forklift. The two luffing supports 8 and 9 lie flat on the auxiliary boom 3 for reasons pertaining to transportation. The hoisting rope 14 is unwound from the main hoist 15 of the mobile crane and connected to the multiple-part connection beam line 13. This line is permanently connected to the lower luffing support 9. The two luffing supports are connected to one another by a traction member line 17.

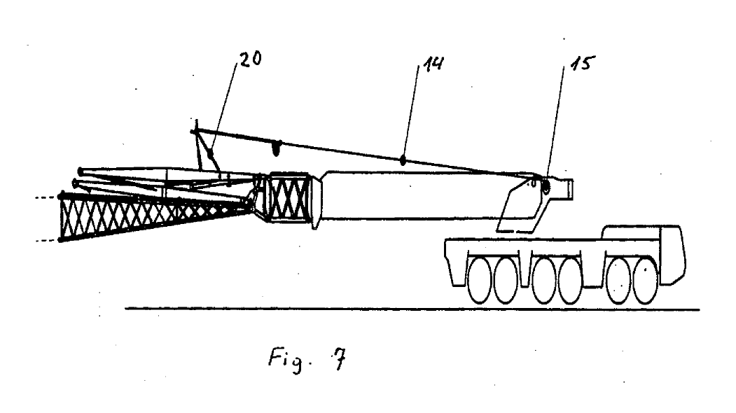

FIG. 7

As the hoisting rope 14 is wound onto the hoist 15, the mounting frame 20 starts to raise itself, the connection beam line 13 starts to tighten initially toward the right-hand side of the mounting frame 20 and then also towards the left-hand side of the mounting frame 20 until the lower luffing support 9 is lifted.

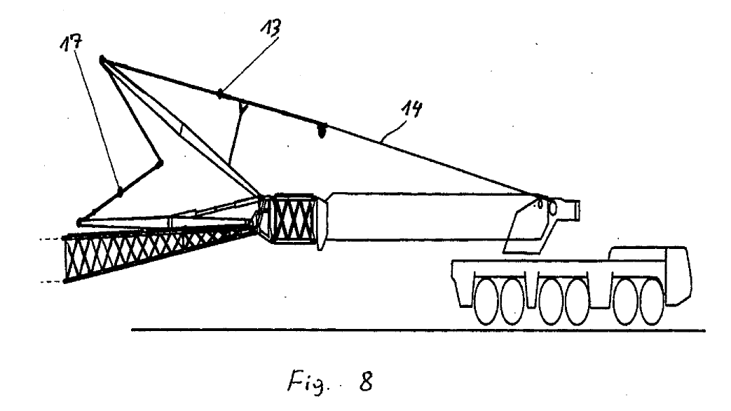

FIG. 8

The main hoist 15 is wound up further, the traction member line 17 between the luffing supports 8 and 9 starts to tighten. The mounting frame 20 is prevented from falling back from its position toward the rear by the rigging screws.

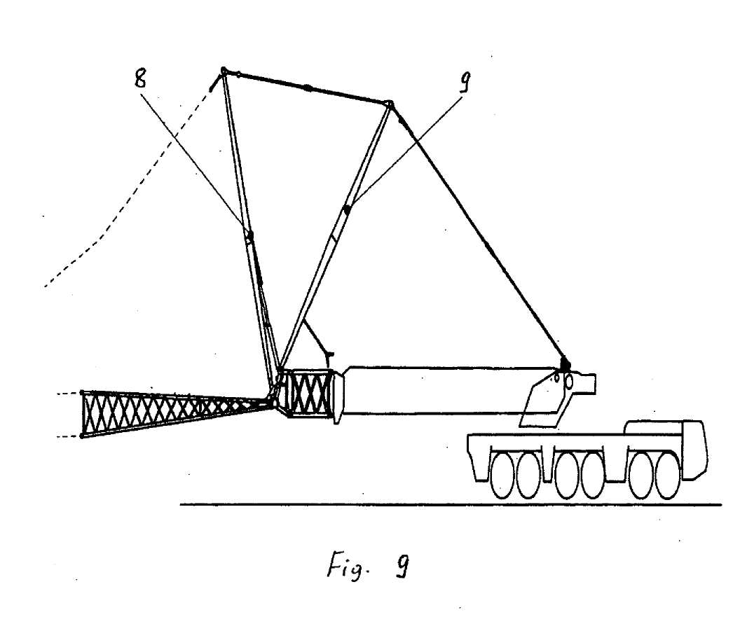

FIG. 9

The connection beam line 13 arrives in its end position in front of the main hoist 15, the luffing supports 8 and 9 are in the final position, and the work step is terminated.

Dismantling is carried out in the reverse sequence.

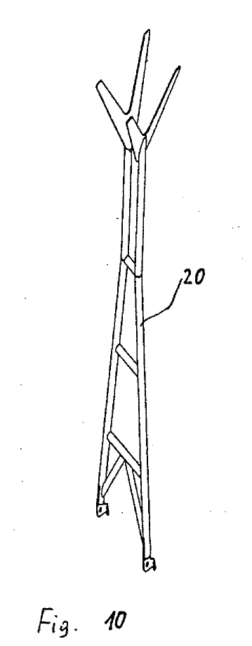

FIG. 10

This drawing shows an embodiment example for the mounting frame 20. This mounting frame 20 comprises a welded construction which is mounted so as to be rotatable (swivelable) on the lower luffing support. Rigging gear which prevents overturning of the mounting frame is provided at the bearing feet. A fork in which the connection beam line 13 described above can be deposited—as can be seen from FIGS. 6 to 9—is located at the upper end of the mounting frame.

During dismantling, the rigging screws also serve at the same time to fix the mounting frame 20 in its position in such a way that the connection beam line 13 is received again by the fork shape of the mounting frame 20.

This connection beam line 13 pulls the mounting frame 20 up when mounting the slewable auxiliary boom until it comes to a stop at the rigging gear. In a corresponding manner, the mounting frame 20 is carried along when the connection beam line 13 is released during dismantling and is moved into its transporting position (FIG. 6).

1-16. (canceled)

17. An auxiliary device for mounting an auxiliary boom at the main boom of a mobile crane, comprising:
a support mounted at the main boom in the vicinity of a head of the main boom; and
wherein the support is configured to guide a hoisting rope of the main boom to an articulation point at the auxiliary boom.

18. The auxiliary device according to claim 17, wherein the support comprises, a lower luffing support and an upper luffing support, each luffing support having a foot and a free end, the two luffing supports being situated near one another by their respective feet and their respective free ends are coupled to one another.

19. The auxiliary device according to claim 18, wherein the respective free ends of the lower and upper luffing supports are coupled to one another by a traction member line.

20. The auxiliary device according to claim 17, wherein the auxiliary boom is connected to the head of the main boom by an adapter, and the support is located at the adapter.

21. The auxiliary device according to claim 18, further comprising:
a mounting frame connected to the lower luffing support; and
a connection beam line configured for connection to the hoisting rope of the main hoist, the connection bean line being articulated at the free end of the lower luffing support.

22. The auxiliary device according to claim 21, wherein the connection beam line comprises a plurality of members which are connected to one another.

23. The auxiliary device according to claim 18, wherein the lower and upper luffing supports are configured to be deposited generally flat on the auxiliary boom for transport.

24. The auxiliary device according to claim 22, wherein the connection beam line comprising multiple sections is connected to the lower luffing support.

25. The auxiliary device according to claim 21, wherein the connection beam line is connected to the hoisting rope by a tackle block.

26. The auxiliary device according to claim 19, wherein the lower and upper luffing supports are permanently connected by the traction member line.

27. The auxiliary device according to claim 21, wherein the mounting frame is constantly connected to the lower luffing support.

28. The auxiliary device according to claim 27, wherein the mounting frame is swivelably mounted on the lower luffing support.

29. The auxiliary device according to claim 21, wherein the mounting frame is fork-shaped at a free end remote of the lower luffing support configured for receiving the connection beam line.

30. A method for mounting an auxiliary boom at the main boom of a mobile crane, using the auxiliary device of claim 17 comprising:
guiding the hoisting rope via the support to the auxiliary boom;
fastening the hoisting rope to the auxiliary boom;
connecting the auxiliary boom to the main boom at least by a lower articulation point; and
forming a connection to an upper articulation point between the auxiliary boom and the main boom by tightening the hoisting rope.

31. A method for mounting an auxiliary boom at the main boom of a mobile crane using the auxiliary device having of claim 18 comprising:
unwinding the hoisting rope from a main hoist of the mobile crane connected to a multiple-section connection beam line;
winding the hoisting rope onto the hoist raising the mounting frame;
tightening the connection beam line initially toward a right-hand side of the mounting frame and then towards a left-hand side of the mounting frame until the lower luffing support is lifted;
tightening the traction member line between the luffing supports as the main hoist is wound up further until the upper and lower luffing supports are in their end position; and
dismantling the auxiliary boom in a reverse sequence.

32. A method for mounting an auxiliary boom using the auxiliary device of claim 18, comprising:
mounting the auxiliary boom at a head of the main boom, wherein the lower luffing support and the upper luffing support lie flat on the auxiliary boom;
unwinding the hoisting rope connected to the connection beam, which is permanently connected to the lower luffing support, from a main hoist of a mobile crane and is, wherein the two luffing supports are connected to one another by a traction member line;
winding the hoisting rope onto the hoist, whereby the luffing supports are erected;
connecting the connection beam to a floating crossbar;
unwinding the hoisting rope so the floating crossbar raises itself along a line from the fixed crossbar to a tip of the lower luffing support;
tightening a tackle block;
uncoupling the hoisting rope from the connection beam after the tackle block is tightened;
lifting the main boom by a luffing cylinder while the adjusting hoist is unwound so that a distance between the floating crossbar and the fixed crossbar is increased; and
rewinding the adjusting hoist starting from a previously determined main boom angle position so that the distance between the floating crossbar and the fixed crossbar decreases so that the adjustable auxiliary boom is lifted because the adjustable auxiliary boom is connected to the upper luffing support by another traction member line.
